(19) United States
(12) Patent Application Publication
(10) Pub. No.: US 2022/0116808 A1
(43) Pub. Date: Apr. 14, 2022

(54) MEASUREMENT REPORTING METHOD AND APPARATUS

(71) Applicant: BEIJING SPREAD TRUM HI-TECH COMMUNICATIONS TECHNOLOGY CO., LTD., Beijing (CN)

(72) Inventor: Hualei WANG, Beijing (CN)

(21) Appl. No.: 17/422,154

(22) PCT Filed: Dec. 31, 2019
(86) PCT No.: PCT/CN2019/130406

§ 371 Date: Dec. 29, 2021

(30) Foreign Application Priority Data
Jan. 11, 2019 (CN) 201910028271.0

(51) Int. Cl. H04W 24/10; H04W 24/08

(52) U.S. Cl. CPC H04W 24/10; H04W 24/08

(57) ABSTRACT

A terminal device receives network configuration information; when the terminal device detects the network configuration information for instructing the terminal device to measure channel state information (CSI) for a designated panel, the terminal device performs CSI measurement on the designated panel and obtains a CSI measurement result of the designated panel; the terminal device generates a CSI measurement report based on the CSI measurement result of the designated panel; and the terminal device sends the CSI measurement report.

### TECHNICAL FIELD

The present disclosure relates to the technical field of communication, in particular to a measurement reporting method and apparatus, and a terminal device information acquisition method and apparatus.

### BACKGROUND

Generally, CSI (channel state information) can represent a channel attribute of a communication link. CSI can adapt a communication system to a current channel condition, and provide a guarantee for high-reliability and high-speed communication in a multi-antenna system.

In Release 15 version of 3GPP 5G, a protocol does not support measurement reporting at a terminal panel level, and a terminal device only performs CSI measurement according to its own configuration. In this case, even if the terminal device is configured with multiple panels, the terminal device cannot reflect, in a CSI report, downlink channel quality based on each panel.

### SUMMARY

In view of the foregoing, the present disclosure provides a measurement reporting method and apparatus, and a terminal device information acquisition method and apparatus.

According to one aspect of the present disclosure, there is provided a measurement reporting method applied to a terminal device, the method comprising: receiving network configuration information; in response to detecting the network configuration information for instructing the terminal device to measure channel state information (CSI) for a designated panel, performing CSI measurement on the designated panel and obtaining a CSI measurement result of the designated panel; generating a CSI measurement report based on the CSI measurement result of the designated panel; and sending the CSI measurement report.

Optionally, said network configuration information for instructing the terminal device to measure the CSI for the designated panel comprises: the network configuration information configured to instruct the terminal device to perform joint CSI measurement for a plurality of designated panels, or the network configuration information configured to instruct the terminal device to perform CSI measurement for each designated panel.

Optionally, the CSI measurement report comprises a first part and a second part, in response to the terminal device detecting the network configuration information for instructing the terminal device to perform CSI measurement for each designated panel; and said terminal device generating the CSI measurement report based on the CSI measurement result of the designated panel comprises: the terminal device causing the CSI measurement result of a panel among the plurality of the designated panels that meets a preset condition to be put into the first part, and causing the CSI measurement result of a panel among the designated panels that does not meet the preset condition to be put into the second part.

Optionally, the preset condition comprises any one or more of the following: a panel with the CSI measurement result comprising a reference RSRP value and/or a reference SINR value, a panel with a specific panel identification number, or a panel with a received synchronization signal block (SSB) signal decoded.

Optionally, said causing the CSI measurement result of the panel that does not meet the preset condition to be put into the second part further comprises: prioritizing a plurality of CSI measurement results in the second part of the CSI measurement report based on a preset ranking rule; and the method further comprises: the terminal device deleting one or more CSI measurement results with lowest priorities in the second part, in response to that the CSI measurement results in the second part need to be deleted.

Optionally, the ranking rule comprises any one of the following: a priority of the CSI measurement result corresponding to a panel with a high RSRP value being higher than a priority of the CSI measurement result corresponding to a panel with a low RSRP value; a priority of the CSI measurement result corresponding to a panel with a high SINR value being higher than a priority of the CSI measurement result corresponding to a panel with a low SINR value; or a priority of the CSI measurement result corresponding to a panel with a small identification number being higher than a priority of the CSI measurement result corresponding to a panel with a large identification number.

Optionally, the designated panel comprises all panels of the terminal device, or a part of all panels of the terminal device being designated.

According to another aspect of the present disclosure, there is provided a terminal device information acquisition method applied to a network side, the method comprising: transmitting network configuration information to a terminal device, the network configuration information configured to instruct the terminal device to measure CSI for a designated panel; and receiving a CSI measurement report sent by the terminal device, the CSI measurement report comprising a CSI measurement result of the designated panel measured by the terminal device.

According to another aspect of the present disclosure, there is provided a measurement reporting apparatus applied to a terminal device, the apparatus comprising: a first receiving module configured to receive network configuration information; a measurement module configured to perform channel state information (CSI) measurement on a designated panel and obtain a CSI measurement result of the designated panel in response to detecting the network configuration information for instructing the terminal device to measure CSI for the designated panel; a generation module configured to generate a CSI measurement report based on the CSI measurement result of the designated panel; and a reporting module configured to send the CSI measurement report.

Optionally, the measurement module comprises: a first measurement submodule, in which the network configuration information is configured to instruct the terminal device to perform joint CSI measurement for a plurality of designated panels, or a second measurement submodule, in which the network configuration information is configured to instruct the terminal device to perform CSI measurement for each designated panel.

Optionally, the CSI measurement report comprises a first part and a second part, in response to the terminal device detecting the network configuration information for instructing the terminal device to perform CSI measurement for each designated panel; and the generation module comprises: a determination submodule configured to cause the CSI measurement result of a panel among the plurality of the designated panels that meets a preset condition to be put into the first part, and causing the CSI measurement result of a panel among the designated panels that does not meet the preset condition to be put into the second part.

Optionally, the preset condition comprises any one or more of the following: a panel with the CSI measurement result comprising a reference RSRP value and/or a reference SINR value, a panel with a specific panel identification number, or a panel with a received SSB signal decoded.

Optionally, the determination submodule further comprises: a ranking submodule configured to prioritize a plurality of CSI measurement results in the second part of the CSI report based on a preset ranking rule; and the apparatus further comprises: a deletion module configured to delete one or more CSI measurement results with lowest priorities in the second part, in the response that the CSI measurement results in the second part need to be deleted.

Optionally, the ranking rule comprises any one of the following: a priority of the CSI measurement result corresponding to a panel with a high RSRP value being higher than a priority of the CSI measurement result corresponding to a panel with a low RSRP value; a priority of the CSI measurement result corresponding to a panel with a high SINR value being higher than a priority of the CSI measurement result corresponding to a panel with a low SINR value; or a priority of the CSI measurement result corresponding to a panel with a small identification number being higher than a priority of the CSI measurement result corresponding to a panel with a large identification number.

Optionally, the designated panel comprises all panels of the terminal device, or a part of all panels of the terminal device being designated.

According to another aspect of the present disclosure, there is provided a terminal device information acquisition apparatus applied to a network side, the apparatus comprising: a transmission module configured to transmit network configuration information to a terminal device, the network configuration information configured to instruct the terminal device to measure CSI for a designated panel; and a second receiving module configured to receive a CSI measurement report sent by the terminal device, the CSI measurement report comprising a CSI measurement result of the designated panel measured by the terminal device.

According to another aspect of the present disclosure, there is provided a measurement reporting apparatus applied to a terminal device, the apparatus comprising: a processor; and a memory for storing processor executable instructions, wherein the processor is configured to implement the above method.

According to another aspect of the present disclosure, there is provided a terminal device information acquisition apparatus a network side, the apparatus comprising: a processor; and a memory for storing processor executable instructions, wherein the processor is configured to implement the above method.

According to another aspect of the present disclosure, there is provided a non-transitory computer readable storage medium having computer program instructions stored thereon, wherein the computer program instructions, when executed by a processor, implement the above method.

In an embodiment of the present disclosure, when the terminal device detects that the received network configuration information is configured to instruct the terminal device to perform channel state information (CSI) measurement for the designated panels, the terminal device performs the measurement and obtains the CSI measurement results of the designated panels and sends the CSI measurement report including the CSI measurement results. In this way, this embodiment of the present disclosure, by including information that instructs the terminal device to perform CSI measurement for the designated panels in the network configuration information, can make the terminal device use the designated panels for CSI measurement in a standardized manner such that the terminal device can reflect, in the CSI measurement report, the downlink channel quality based on each designated panel, and make the network side aware of the downlink channel quality based on each designated panel, thereby effectively achieving energy saving and system performance improvement on a terminal side.

Other features and aspects of the present disclosure will become apparent from the following detailed description of exemplary embodiments with reference to the accompanying drawings.

### BRIEF DESCRIPTION OF THE DRAWINGS

The accompanying drawings which are incorporated in and constitute a part of the specification, together with the specification, illustrate the exemplary embodiments, features and aspects of the present disclosure and serve to explain the principle of the present disclosure.

FIG. 1 is a flowchart of a measurement reporting method according to an exemplary embodiment.

FIG. 2 is a flowchart of a measurement reporting method according to an exemplary embodiment.

FIG. 3 is a flowchart of a terminal device information acquisition method according to an exemplary embodiment.

FIG. 4 is a block diagram of a measurement reporting apparatus according to an exemplary embodiment.

FIG. 5 is a block diagram of a measurement reporting apparatus according to an exemplary embodiment.

FIG. 6 is a block diagram of a terminal device information acquisition apparatus according to an exemplary embodiment.

FIG. 7 is a block diagram of a measurement reporting apparatus according to an exemplary embodiment.

FIG. 8 is a block diagram of a terminal device information acquisition apparatus according to an exemplary embodiment.

### DETAILED DESCRIPTION

Hereinafter, various exemplary embodiments, features and aspects of the present disclosure will be described in detail with reference to the accompanying drawings. In the drawings, the same reference signs refer to elements with the same or similar functions. Although various aspects of embodiments are shown in the drawings, the drawings are not necessarily drawn to scale unless otherwise specified.

The special word “exemplary” here means “serving as an example, embodiment or illustration”. Any embodiment described herein as “exemplary” is not necessarily to be interpreted as superior to or better than other embodiments.

In addition, in order to better explain the present disclosure, numerous details are given in the following specific embodiments. It should be understood by those skilled in the art that the present disclosure can still be implemented without certain details. In some examples, methods, means, elements and circuits well known to those skilled in the art are not described in detail in order to highlight the gist of the present disclosure.

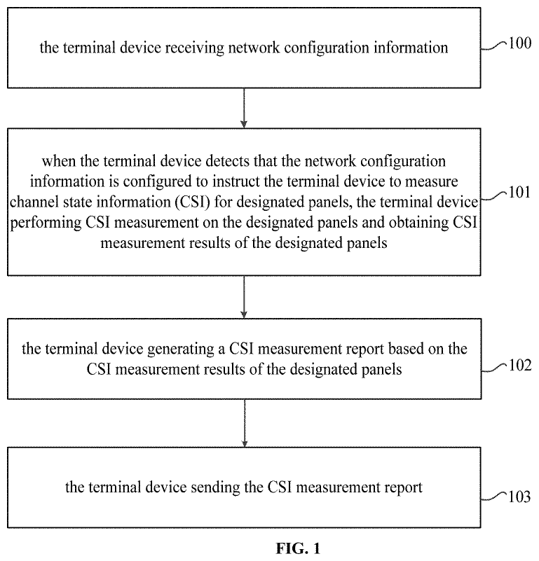

FIG. 1 is a flowchart of a measurement reporting method according to an exemplary embodiment. The method can be applied to a terminal device with wireless communication functions, such as a mobile phone, a tablet computer, a smart watch, etc., and the embodiments of the present disclosure do not limit the type of the terminal device. As shown in FIG. 1, the method can comprise:

in 100: the terminal device receiving network configuration information;

in 101: when the terminal device detects that the network configuration information is configured to instruct the terminal device to measure channel state information (CSI) for designated panels, the terminal device performing CSI measurement on the designated panels and obtaining CSI measurement results of the designated panels;

in 102: the terminal device generating a CSI measurement report based on the CSI measurement results of the designated panels; and

in 103: the terminal device sending the CSI measurement report.

In an embodiment of the present disclosure, generally speaking, the network configuration information may include information for instructing the terminal device to perform CSI measurement. A panel can be used to represent an antenna, an antenna group, a beam group or the like of a terminal device. It should be noted that other suitable names can also be selected to refer to the antenna, antenna group, beam group or the like of the terminal device. The embodiments of the present disclosure do not limit the names of the antenna, antenna group, or beam group of the terminal device.

In an embodiment of the present disclosure, the designated panels may include all panels of the terminal device. The designated panels may also include a part of designated panels among all panels of the terminal device. For example, the terminal device may include four panels with panel identification numbers of 0, 1, 2, and 3 in sequence, and the designated panels may include two panels with the panel identification numbers of 0 and 1. It should be noted that suitable panels can be selected as the designated panels according to the actual requirements of CSI measurement, and the embodiments of the present disclosure do not limit the number and the characteristics of the designated panels.

Optionally, the network configuration information including information that instructs the terminal device to perform CSI measurement may be included in CSI-ReportConfig (channel state information report configuration) information. It should be noted that the network configuration information including information that instructs the terminal device to perform CSI measurement can also be included in other information as required, and embodiments of the present disclosure do not limit the specific form of the network configuration information.

As an example of this embodiment, the network side may transmit the network configuration information to the terminal device when it needs to acquire the CSI measurement report of the terminal device (for example, the network side needs to acquire the CSI measurement report of the terminal device when carrying out activities such as determining an event or executing a certain type of algorithm, etc., and then it may initiate an inquiry for the CSI measurement report of the terminal device and transmit the network configuration information to the terminal device). Generally speaking, the network side can represent a radio transceiver station that transmits information with a mobile terminal in a certain radio coverage area. The network side may include, for example, a BS (Base Station), an RRU (Radio Remote Unit) or the like, and the embodiments of the present disclosure do not limit the specific form of the network side.

The terminal device can receive and parse the network configuration information sent by the network side, and when detecting that the network configuration information includes information for instructing the terminal device to perform CSI measurement for the designated panels, perform CSI measurement on the designated panels and obtain the CSI measurement results of the designated panels. For example, the network configuration information may include an “enabled” instruction or a “disabled” instruction. The “enabled” instruction may be used to instruct the terminal device to employ the designated panels for CSI measurement, and send the CSI measurement results of the designated panels. The “disabled” instruction may be used to instruct the terminal device to employ panels selected by the terminal device for joint CSI measurement according to its own configuration, and send the obtained CSI measurement. When the terminal device parses the received network configuration information and determines that it contains the “enabled” instruction, it can report the CSI measurement information for the designated panels. It should be noted that a suitable instruction can be selected as needed to instruct the terminal device to perform CSI measurement. The present disclosure does not limit the specific form of the instruction for instructing the terminal device to perform CSI measurement.

Then, the terminal device can generate a CSI measurement report based on the CSI measurement results of the designated panels, and can send the CSI measurement report. The terminal device reporting the CSI measurement report can be carried out in such a way that the terminal device encapsulates the CSI measurement report data in a message to be transmitted by the terminal device and transmits the message when it can be transmitted. The network side (such as a BS or an RRU, etc.) can receive the message transmitted by the terminal device, and can parse the CSI measurement results reported by the terminal from the message. The network side can carry out activities such as determining an event or executing a certain type of algorithm according to the CSI measurement results. It should be noted that the embodiments of the present disclosure do not limit how the network side utilizes the CSI measurement results.

In an embodiment of the present disclosure, when the terminal device detects that the received network configuration information is configured to instruct the terminal device to perform channel state information (CSI) measurement for the designated panels, the terminal device performs the measurement, obtains CSI measurement results of the designated panels, and sends the CSI measurement report including the CSI measurement results. In this way, this embodiment of the present disclosure, by including information that instructs the terminal device to perform CSI measurement for the designated panels in the network configuration information, can make the terminal device to use the designated panels for CSI measurement in a standardized manner, such that the terminal device can reflect, in the CSI measurement report, the downlink channel quality based on each designated panel, and make the network side aware of the downlink channel quality based on each designated panel, thereby effectively achieving energy saving and system performance improvement on a terminal side.

Optionally, the network configuration information can be transmitted from the network side to the terminal device. The network configuration information can also be transmitted to another apparatus by the network side, and then forwarded to the terminal device by said another apparatus. The terminal device can send the CSI measurement report to the network side. The terminal device may also send the CSI measurement report to another apparatus, and then said another apparatus forwards the CSI measurement report to the network side. The embodiments of the present disclosure do not limit the transmission mode of the network configuration information and the reporting mode of CSI measurement report.

Optionally, 102 may include the network configuration information configured to instruct the terminal device to perform joint CSI measurement for the designated panels. When the terminal device detects that the network configuration information is configured to instruct the terminal device to perform joint CSI measurement for the designated panels, it can obtain one CSI measurement result for the designated panels, and obtain the CSI measurement report based on the CSI measurement result.

Optionally, 102 may include the network configuration information being configured to instruct the terminal device to perform CSI measurement of each panel for the designated panels. When the terminal device detects that the network configuration information is configured to instruct the terminal device to perform CSI measurement for each panel, it can generate one CSI measurement result for each designated panel and obtain the CSI measurement report based on multiple CSI measurement results.

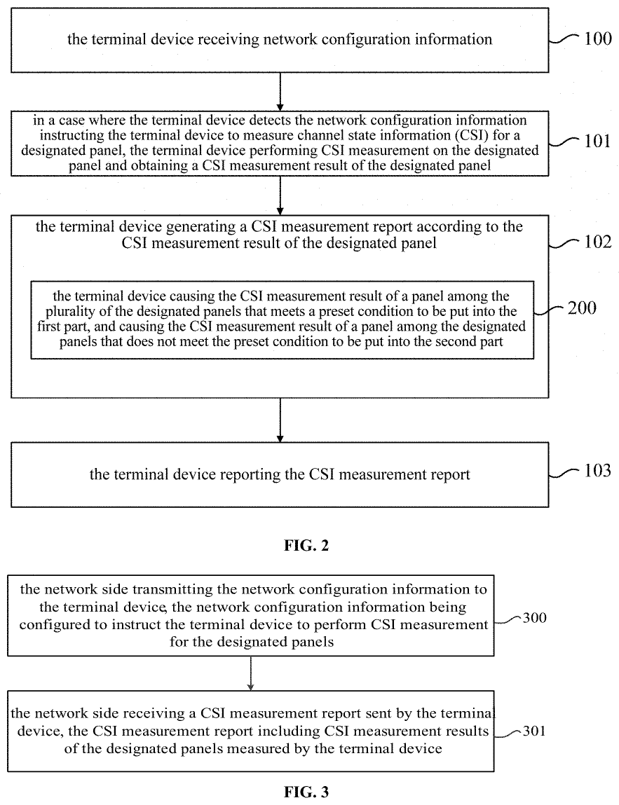

FIG. 2 is a flowchart of a measurement reporting method according to an exemplary embodiment. As shown in FIG. 2, FIG. 2 is different from FIG. 1 in that 102 may include 200. In 200, the terminal device causing the CSI measurement results of the panels among the designated panels that meet the preset condition to be put into the first part, and causing the CSI measurement results of the panels among the designated panels that do not meet the preset condition to be put into the second part.

As an example of this embodiment, when the terminal device detects that the network configuration information is configured to instruct the terminal device to perform CSI measurement of each panel for the designated panels, it can obtain one CSI measurement result for each designated panel, that is, multiple CSI measurement results are obtained, and the CSI measurement report can include a first part and a second part. For the multiple CSI measurement results, the terminal device can cause the CSI measurement results of the panels that meet the preset condition to be included into the first part, and cause the CSI measurement results of the panels that do not meet the preset condition to be included into the second part (for example, if the preset condition refers to a specific panel identification number, the CSI measurement results corresponding to the panels with specific panel identification numbers can be included into the first part, and the CSI measurement results of the panels with other panel identification numbers can be included into the second part).

Before sending the CSI measurement report, the terminal device can detect whether the data volume of the CSI measurement report is too large (for example, the terminal device can determine that the data volume of the CSI measurement report is too large when it detects that the data volume of the CSI measurement report exceeds a detection threshold). When the terminal device detects that the data volume of the CSI measurement report is too large, it can keep the integrity of the data in the first part and reduce the size of the data in the second part (for example, it can compress the data of the second part), and can send the CSI measurement report that includes the data of the first part and the reduced data of the second part.

In this way, in this embodiment, the CSI measurement results of the panels meeting the preset condition are included into the first part of the CSI measurement report, and if the size of the CSI measurement report needs to be reduced, the integrity of the data of the first part is kept, thereby ensuring that the CSI measurement results of the panels meeting the preset condition among the designated panels are reported preferentially and completely.

Optionally, the preset condition includes any one or more of the following: a panel with the CSI measurement result including a reference RSRP value and/or a reference SINR value, a panel with a specific panel identification number, and a panel with a received SSB signal decoded.

RSRP (Reference Signal Receiving Power) can represent a linear average value of received power (in watts) on resource elements carrying a reference signal in a measuring frequency bandwidth. Generally, the larger the RSRP value, the better the signal coverage status. For example, the reference RSRP value can be set (it should be noted that the reference RSRP value can be set according to experience for example, and the method of setting the reference RSRP value is not limited in the embodiments of the present disclosure), and the panel of which the CSI measurement result includes the reference RSRP value can be regarded as the panel meeting the preset condition. In this way, if the data volume of the CSI measurement report is too large, it is possible to ensure that the CSI measurement results of the panels with better signal coverage are reported preferentially and completely, such that the network side can be aware of the downlink channel quality of the panels with better signal coverage, which is more conducive to energy saving and system performance improvement of the terminal side.

SINR (Signal to Interference Plus Noise Ratio) can represent a ratio of the strength of useful signals received to the strength of received interference signals (noise and interference). Generally, the larger the SINR value, the better the signal quality. For example, the reference SINR value can be set (it should be noted that the reference SINR value can be set according to experience for example, and the method of setting the reference SINR value is not limited in the embodiments of the present disclosure), and the panel of which the measurement result includes the reference SINR value can be regarded as the panel meeting the preset condition. In this way, it is possible to ensure that the CSI measurement results of the panels with better received signal quality are reported preferentially and completely, such that the network side can be aware of the downlink channel quality of the panels with better received signal quality, which is more conducive to energy saving and system performance improvement of the terminal side.

Generally, the panel of which a received SSB signal (Synchronization Signal Block) is selected for decoding can have better stability. Taking the panel with the received SSB signal decoded as the panel meeting the preset condition can ensure that the CSI measurement result of the panel with better stability is reported preferentially and completely, such that the network side can be aware of the downlink channel quality of the panel with better stability, which is more conducive to energy saving and system performance improvement of the terminal side.

In an example, 200 may further include prioritizing the CSI measurement results in the second part of the CSI report based on a preset ranking rule.

For example, the terminal device can determine the CSI measurement results, which need to be included into the second part, of multiple panels that do not meet the preset condition, and can prioritize the CSI measurement results of multiple panels based on the preset ranking rule.

The method may further comprise the terminal device deleting one or more CSI measurement results with lowest priorities in the second part when the CSI measurement results in the second part need to be deleted.

For example, the terminal device can detect whether the data volume of the CSI measurement report including the first part and the second part is too large, and delete one or more CSI measurement results with the lowest priorities in the second part when detecting that the data volume of the CSI measurement report is too large, so as to reduce the data volume of the CSI measurement report until the terminal device confirms that the data volume of the reduced CSI measurement report is suitable for reporting. In this way, it can be ensured that not only the CSI measurement results of the panels in the first part are reported preferentially and completely, but also the CSI measurement results with higher priority in the second part are reported completely.

Optionally, the ranking rule may include such a rule that the priority of the CSI measurement result corresponding to a panel with a high measured RSRP value is higher than the priority of the CSI measurement result corresponding to a panel with a low measured RSRP value. Therefore, it can be ensured that the CSI measurement results of the panels with stronger signal coverage ability in the second part are reported preferentially and completely.

Optionally, the ranking rule may include such a rule that the priority of the CSI measurement result corresponding to a panel with a high measured SINR value is higher than the priority of the CSI measurement result corresponding to a panel with a low measured SINR value. Therefore, it can be ensured that the CSI measurement results of the panels with better signal quality in the second part are reported preferentially and completely.

Optionally, the ranking rule may include such a rule that the priority of the CSI measurement result corresponding to a panel with a small identification number is higher than the priority of the CSI measurement result corresponding to a panel with a large identification number.

In an application example, the following description will be made with a mobile phone as the terminal device and all panels of the mobile phone as the designated panels in an example.

When the network side needs to obtain the CSI measurement report of the mobile phone, it can transmit the network configuration information to the mobile phone, and the network configuration information can be included in the CSI-ReportConfig information. The network configuration information may include an “enabled” instruction or a “disabled” instruction, in which the “enabled” instruction may be used to instruct the mobile phone to perform CSI measurement of each panel for all its panels and report the CSI measurement result of each panel of all the panels of the mobile phone, and the “disabled” instruction may be used to instruct the mobile phone to employ the panels selected by the mobile phone to perform joint CSI measurement according to its own configuration and report the CSI measurement results of the panels selected by the mobile phone. The mobile phone can receive and parse the network configuration information from the network side. When the mobile phone detects that the network configuration information includes the “enabled” instruction, it can employ all the panels of the mobile phone to perform CSI measurement of each panel.

Then, the mobile phone may cause the CSI measurement results of the panels that meet the preset condition (for example, the preset condition may include one or more of the following: a panel with the CSI measurement result including a reference RSRP value and/or a reference SINR value, a panel with a specific panel identification number, or a panel with a received SSB signal decoded) to be included into part 1 (an example of the first part) of the CSI measurement report; and cause the CSI measurement results of the panels that do not meet the preset condition to be included into part 2 (an example of the second part) of the CSI measurement report.

The mobile phone can prioritize the CSI measurement results of the multiple panels in the second part based on the preset ranking rule (for example, the preset ranking rule can include any one of the following three: the priority of the CSI measurement result corresponding to a panel with a high measured RSRP value being higher than the priority of the CSI measurement result corresponding to a panel with a low measured RSRP value; the priority of the CSI measurement result corresponding to a panel with a high measured SINR value being higher than the priority of the CSI measurement result corresponding to a panel with a low measured SINR value; or the priority of the CSI measurement result corresponding to a panel with a small identification number being higher than the priority of the CSI measurement result corresponding to a panel with a large identification number).

The mobile phone can detect whether the data volume of the CSI measurement report is too large before sending the CSI measurement report. When the mobile phone detects that the data volume of the CSI measurement report is too large, it can keep the integrity of data in part 1 and delete one or more CSI measurement results with lower priority in part 2, so as to reduce the CSI measurement report until the mobile phone confirms that the data volume of the reduced CSI measurement report is suitable for sending. Finally, the mobile phone can send the reduced CSI measurement report.

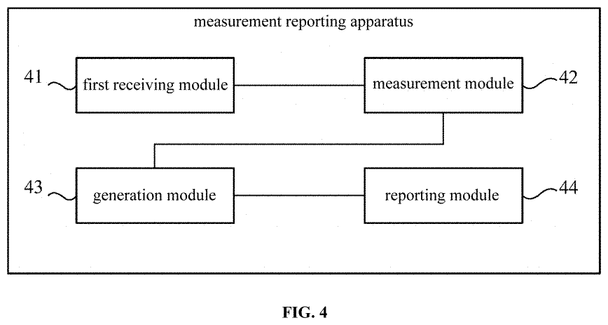

FIG. 3 is a flowchart of a terminal device information acquisition method according to an exemplary embodiment. The method can be applied to a network side. As shown in FIG. 3, the method can comprise:

in 300: the network side transmitting the network configuration information to the terminal device, the network configuration information being configured to instruct the terminal device to perform CSI measurement for the designated panels; and

in 301: the network side receiving a CSI measurement report sent by the terminal device, the CSI measurement report including CSI measurement results of the designated panels measured by the terminal device.

The description of 300 and 301 can refer to the above description and will not be repeated here.

FIG. 4 is a block diagram of a measurement reporting apparatus according to an exemplary embodiment. The apparatus is applied to a terminal device. As shown in FIG. 4, the apparatus may comprise:

a first receiving module 41 configured to receive the network configuration information;

a measurement module 42 configured to perform channel state information (CSI) measurement on the designated panels and obtain the CSI measurement results of the designated panels when it is detected that the network configuration information is configured to instruct the terminal device to perform CSI measurement for the designated panels;

a generation module 43 configured to generate a CSI measurement report based on the CSI measurement results of the designated panels; and

a reporting module 44 configured to send the CSI measurement report.

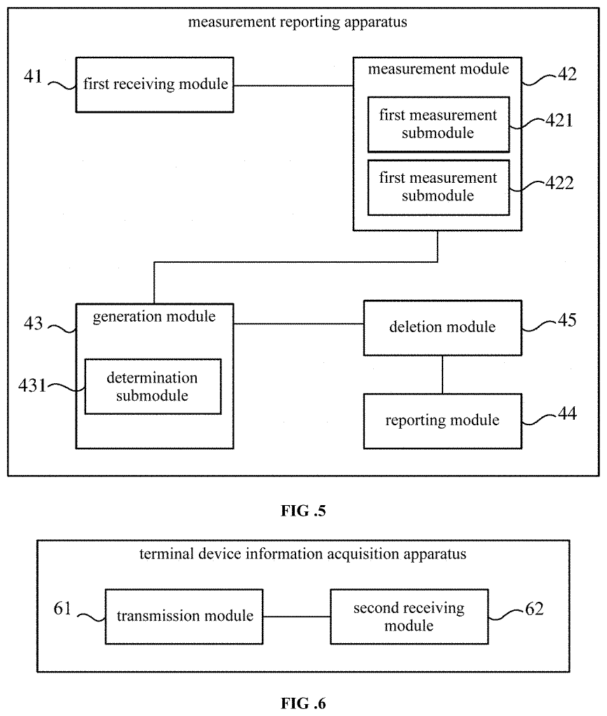

FIG. 5 is a block diagram of a measurement reporting apparatus according to an exemplary embodiment. Components in FIG. 5 with the same reference signs as those in FIG. 4 have the same functions, and the detailed description of these components will be omitted for the sake of brevity.

As shown in FIG. 5, optionally, the measurement module 42 comprises:

a first measurement submodule 421, in which the network configuration information is configured to instruct the terminal device to perform joint CSI measurement for the designated panels, or

a second measurement submodule 422, in which the network configuration information is configured to instruct the terminal device to perform CSI measurement of each panel for the designated panels.

Optionally, the CSI measurement report includes a first part and a second part when the terminal device detects that the network configuration information is configured to instruct the terminal device to perform CSI measurement of each panel for the designated panels; and the generation module 43 comprises:

a determination submodule 431 configured to cause the CSI measurement results of the panels among the designated panels that meet the preset condition to be included into the first part, and cause the CSI measurement results of the panels among the designated panels that do not meet the preset condition to be included into the second part.

Optionally, the preset condition includes any one or more of the following:

a panel with the CSI measurement result including a reference RSRP value and/or a reference SINR value, a panel with a specific panel identification number, or a panel with a received SSB signal decoded.

Optionally, the determination submodule 431 further comprises:

a ranking submodule configured to prioritize the CSI measurement results in the second part of the CSI report based on the preset ranking rule; and

the apparatus further comprises a deletion module 45 configured to delete one or more CSI measurement results with the lowest priorities in the second part when the CSI measurement results in the second part need to be deleted.

Optionally, the ranking rule includes any one of the following:

the priority of the CSI measurement result corresponding to a panel with a high measured RSRP value being higher than the priority of the CSI measurement result corresponding to a panel with a low measured RSRP value;

the priority of the CSI measurement result corresponding to a panel with a high measured SINR value being higher than the priority of the CSI measurement result corresponding to a panel with a low measured SINR value; or

the priority of the CSI measurement result corresponding to a panel with a small identification number being higher than the priority of the CSI measurement result corresponding to a panel with a large identification number.

Optionally, the designated panels include all panels of the terminal device, or a part of all panels of the terminal device being designated.

With regard to the apparatus in the above embodiments, the specific manner in which each module operates has been described in detail in the embodiments related to the method, and detailed description will be omitted here.

FIG. 6 is a block diagram of a terminal device information acquisition apparatus according to an exemplary embodiment. The apparatus can be applied to a network side. As shown in FIG. 6, the apparatus can comprise:

a transmission module 61 configured to transmit the network configuration information to a terminal device, the network configuration information being configured to instruct the terminal device to perform CSI measurement for the designated panels; and

a second receiving module 62 configured to receive a CSI measurement report sent by the terminal device, the CSI measurement report including the CSI measurement results of the designated panels measured by the terminal device.

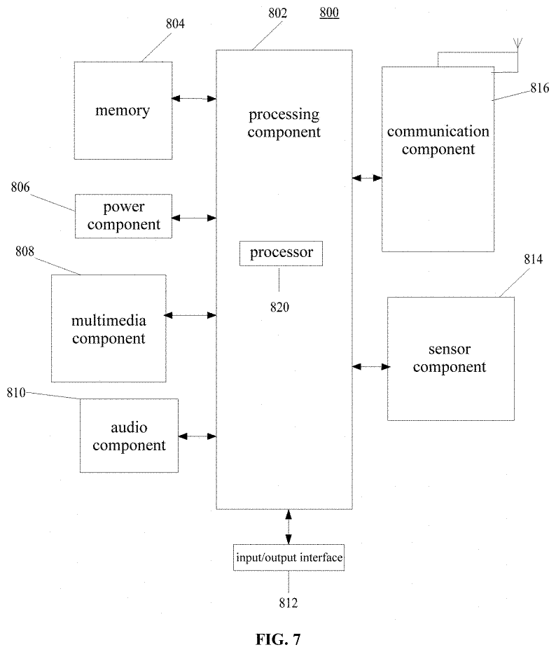

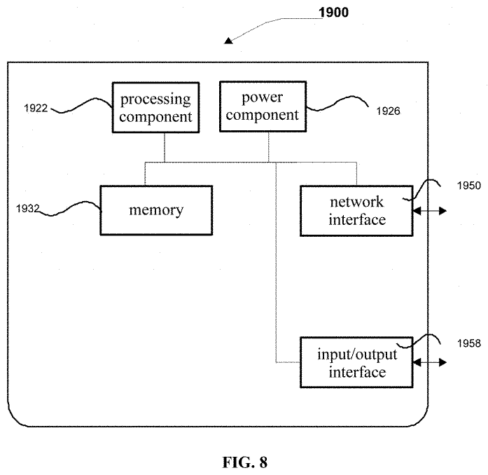

FIG. 7 is a block diagram of a measurement reporting apparatus according to an exemplary embodiment. For example, the apparatus 800 may be a mobile phone, a computer, a digital broadcasting terminal, a messaging device, a game console, a tablet, medical equipment, fitness equipment, a personal digital assistant, etc.

Referring to FIG. 7, the apparatus 800 may comprise one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the apparatus 800, such as operations associated with displaying, telephone call, data communication, camera operation and recording operation. The processing component 802 may comprise one or more processors 820 to execute instructions to complete all or part of the operations of the method described above. In addition, the processing component 802 can comprise one or more modules to facilitate interaction between the processing component 802 and other components. For example, the processing component 802 may comprise a multimedia module to facilitate the interaction between the multimedia component 808 and the processing component 802.

The memory 804 is configured to store various types of data to support operations at the apparatus 800. Examples of such data include instructions for any application or method operating on the apparatus 800, contact data, phone book data, messages, pictures, videos, etc. The memory 804 can be implemented by any type of transitory or non-transitory storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the apparatus 800. The power component 806 may comprise a power management system, one or more power sources, and other components associated with generating, managing, and distributing power for the apparatus 800.

The multimedia component 808 comprises a screen that provides an output interface between the apparatus 800 and a user. In some embodiments, the screen may include a liquid crystal display (LCD) and a touch panel (TP). If the screen includes a touch panel, the screen may be implemented as a touch screen to receive an input signal from the user. A touch panel includes one or more touch sensors to sense touch, sliding, and gestures on the touch panel. The touch sensor may not only sense the boundary of a touch or sliding action, but also detect the duration and pressure related to the touch or sliding operation. In some embodiments, the multimedia component 808 comprises a front camera and/or a rear camera. When the apparatus 800 is in an operation mode, such as a shooting mode or a video mode, the front camera and/or the rear camera can receive external multimedia data. Each front camera and rear camera can be a fixed optical lens system or have a focal length and optical zoom capability.

The audio component 810 is configured to output and/or input audio signals. For example, the audio component 810 comprises a microphone (MIC) configured to receive external audio signals when the apparatus 800 is in an operation mode, such as a call mode, a recording mode and a voice recognition mode. The received audio signals may be further stored in the memory 804 or transmitted via the communication component 816. In some embodiments, the audio component 810 further comprises a loudspeaker for outputting audio signals.

The I/O interface 812 provides an interface between the processing component 802 and a peripheral interface module which may be a keyboard, a click wheel, a button, etc. The button may include but is not limited to a homepage button, a volume button, a start button and a lock button.

The sensor component 814 comprises one or more sensors for providing state assessment of various aspects of the apparatus 800. For example, the sensor component 814 can detect an ON/OFF state of the apparatus 800, and relative positioning of the components, and for example, the components are the display and the keypad of the apparatus 800. The sensor component 814 can further detect the position change of the apparatus 800 or a component of the apparatus 800, presence or absence of user's contact with the apparatus 800, orientation or acceleration/deceleration of the apparatus 800, and temperature change of the apparatus 800. The sensor component 814 may comprise a proximity sensor configured to detect the presence of nearby objects without any physical contact. The sensor component 814 may also comprise an optical sensor, such as a CMOS or CCD image sensor, for use in imaging applications. In some embodiments, the sensor component 814 may further comprise an acceleration sensor, a gyro sensor, a magnetic sensor, a pressure sensor or a temperature sensor.

The communication component 816 is configured to facilitate wired or wireless communication between the apparatus 800 and other apparatuses. The apparatus 800 can access a wireless network based on a communication standard, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further comprises a near field communication (NFC) module to facilitate short-range communication. For example, the NFC module can be implemented based on Radio Frequency Identification (RFID) technology, Infrared Data Association (IrDA) technology, Ultra Wideband (UWB) technology, Bluetooth (BT) technology and other technologies.

In an exemplary embodiment, the apparatus 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements for performing the above-described method.

In an exemplary embodiment, a non-transitory computer readable storage medium is further provided, such as the memory 804 including computer program instructions, which can be executed by the processor 820 of the apparatus 800 to implement the above method.

FIG. 8 is a block diagram of a terminal device information acquisition apparatus according to an exemplary embodiment. For example, a device 1900 can be provided as a server. Referring to FIG. 8, the apparatus 1900 comprises a processing component 1922 which further includes one or more processors, and memory resources represented by a memory 1932 for storing instructions, such as application programs, executable by the processing component 1922. The application programs stored in the memory 1932 may include one or more modules each corresponding to a set of instructions. In addition, the processing component 1922 is configured to execute instructions to implement the above method.

The apparatus 1900 may further comprise a power component 1926 configured to perform power management of the apparatus 1900, a wired or wireless network interface 1950 configured to connect the apparatus 1900 to a network, and an input/output (I/O) interface 1958. The apparatus 1900 can operate based on an operating system stored in the memory 1932, such as Windows Server™, Mac OS X™, Unix™, Linux™, FreeBSD™ or the like.

In an exemplary embodiment, a non-transitory computer readable storage medium is further provided, such as the memory 1932 including computer program instructions, which can be executed by the processing component 1922 of the apparatus 1900 to implement the above-described method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing devices, or other devices to have a series of operations performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A measurement reporting method applied to a terminal device, the method comprising:
receiving network configuration information;
in response to detecting the network configuration information for instructing the terminal device to measure channel state information (CSI) for a designated panel, performing CSI measurement on the designated panel and obtaining a CSI measurement result of the designated panel;
generating a CSI measurement report based on the CSI measurement result of the designated panel; and
sending the CSI measurement report.

2. The method according to claim 1, wherein said network configuration information for instructing the terminal device to measure the CSI for the designated panel comprises:
the network configuration information configured to instruct the terminal device to perform joint CSI measurement for a plurality of designated panels, or
the network configuration information configured to instruct the terminal device to perform CSI measurement for each designated panel.

3. The method according to claim 2, wherein the CSI measurement report comprises a first part and a second part, and
the first part of the CSI measurement report comprises a measurement result of a panel that meets a preset condition, and the second part of the CSI measurement report comprises a measurement result of a panel that does not meet the preset condition.

4. The method according to claim 3, wherein a panel that meets the preset condition comprises any one or more of the following:
a panel with the CSI measurement result comprising a reference RSRP value and/or a reference SINR value,
a panel with a specific panel identification number, or
a panel with a received synchronization signal block (SSB) signal decoded.

5. The method according to claim 3, further comprising:
prioritizing a plurality of CSI measurement results in the second part of the CSI measurement report based on a preset ranking rule; and
deleting one or more CSI measurement results with lowest priorities in the second part, in response to that the CSI measurement results in the second part need to be deleted.

6. The method according to claim 5, wherein the ranking rule comprises any one of the following:
a priority of the CSI measurement result corresponding to a panel with a high RSRP value being higher than a priority of the CSI measurement result corresponding to a panel with a low RSRP value;
a priority of the CSI measurement result corresponding to a panel with a high SINR value being higher than a priority of the CSI measurement result corresponding to a panel with a low SINR value; or
a priority of the CSI measurement result corresponding to a panel with a small identification number being higher than a priority of the CSI measurement result corresponding to a panel with a large identification number.

7. The method according to claim 1, wherein there are a plurality of panels for the terminal device, and the network configuration information is configured to instruct the terminal device to measure CSI for all of the plurality of the panels as designated panels, or measure CSI for a part of the plurality of the panels as the designated panels.

8-16. (canceled)

17. A measurement reporting apparatus applied to a terminal device, the apparatus comprising:
a processor; and
a memory for storing processor executable instructions,
wherein the processor is configured to:
receive network configuration information;
in response to detecting the network configuration information for instructing the terminal device to measure channel state information (CSI) for a designated panel, perform CSI measurement on the designated panel and obtain a CSI measurement result of the designated panel;
generate a CSI measurement report based on the CSI measurement result of the designated panel; and
send the CSI measurement report.

18-20. (canceled)

21. The apparatus according to claim 17, wherein said network configuration information for instructing the terminal device to measure the CSI for the designated panel comprises:
the network configuration information configured to instruct the terminal device to perform joint CSI measurement for a plurality of designated panels, or
the network configuration information configured to instruct the terminal device to perform CSI measurement for each designated panel.

22. The apparatus according to claim 21, wherein the CSI measurement report comprises a first part and a second part, and
the first part of the CSI measurement report comprises a measurement result of a panel that meets a preset condition, and the second part of the CSI measurement report comprises a measurement result of a panel that does not meet the preset condition.

23. The apparatus according to claim 22, wherein a panel that meets the preset condition comprises any one or more of the following:
a panel with the CSI measurement result comprising a reference RSRP value and/or a reference SINR value,
a panel with a specific panel identification number, or
a panel with a received synchronization signal block (SSB) signal decoded.

24. The apparatus according to claim 22, wherein the processor is further configured to:
prioritize a plurality of CSI measurement results in the second part of the CSI measurement report based on a preset ranking rule; and
delete one or more CSI measurement results with lowest priorities in the second part, in response to that the CSI measurement results in the second part need to be deleted.

25. The apparatus according to claim 24, wherein the ranking rule comprises any one of the following:
a priority of the CSI measurement result corresponding to a panel with a high RSRP value being higher than a priority of the CSI measurement result corresponding to a panel with a low RSRP value;
a priority of the CSI measurement result corresponding to a panel with a high SINR value being higher than a priority of the CSI measurement result corresponding to a panel with a low SINR value; or
a priority of the CSI measurement result corresponding to a panel with a small identification number being higher than a priority of the CSI measurement result corresponding to a panel with a large identification number.

26. The apparatus according to claim 17, wherein there are a plurality of panels for the terminal device, and the network configuration information is configured to instruct the terminal device to measure CSI for all of the plurality of the panels as designated panels, or measure CSI for a part of the plurality of the panels as the designated panels.
